(19) United States
(12) Patent Application Publication
(10) Pub. No.: US 2008/0010902 A1
(43) Pub. Date: Jan. 17, 2008

(54) Solid Doorframe And A Sliding Door Assembly

(76) Inventor: Ju Ryong Kim, Seoul (KR)

Correspondence Address: CARLSON GASKEY & OLDS, 400 W MAPLE STE 350, BIRMINGHAM, MI, 48009, US

(21) Appl. No.: 11/574,815

(22) PCT Filed: Jul. 4, 2005
(86) PCT No.: PCT/KR05/02105

§ 371 Date: Mar. 7, 2007

(30) Foreign Application Priority Data
Sep. 21, 2004 (KR) 10-2004-0075310

(51) Int. Cl. E06B 3/42; E06B 1/52

(52) U.S. Cl. 49/404; 49/501; 49/504

(57) ABSTRACT

There is provided a doorframe comprising a frame having a first pressing leg with a first pressing surface, a second pressing leg with a second pressing surface facing the first pressing surface and a connecting portion connecting the first pressing leg and the second pressing leg adjacent their upper ends. A portion of a door panel is received between and supported by the first pressing leg and the second pressing leg. The frame is made through extrusion molding. The doorframe is also provided with a friction member disposed between the door panel and at least one of the pressing surfaces.

### TECHNICAL FIELD

The present invention generally relates to a sliding door assembly. More specifically, the present invention relates to a sliding door assembly with a solid doorframe capable of firmly grasping a door panel due to its increased stiffness and being easily joined to a door hanger.

### BACKGROUND ART

A sliding door assembly is typically installed at the entrance of a building such as hotels to provide the convenience of automatic (via sensors) or semi-automatic (via switches) opening and closing of doors. The sliding door assembly also performs a security function when it is coupled to a user identification system, thus allowing only authorized persons to enter or exit the building.

FIGS. 1 and 2 illustrate a sliding door assembly and a doorframe of prior art.

As shown in FIG. 1, the sliding door assembly includes a door panel 30 and a doorframe 20. The door panel 30, which is the portion that blocks the entrance, is typically made of strengthened glass. One part of the doorframe 20 grasps edges of the door panel 30, while another part is connected to the rail of an automatic door opening/closing system (not shown). The connection between the doorframe 20 and the rail is achieved with a door hanger 10. The lower surface of the door hanger 10 is attached to the doorframe 20 and the upper portion of the door hanger 10 is attached to the rail of the automatic door opening/closing system.

Referring to FIG. 2, the outer structure of the doorframe 20 is obtained by bending a steel plate into a rectangular shape and positioning a core member 24 inside the outer structure. The lower portion of the outer structure has a pair of U-shaped guides 26, which guides the door panel 30 as it is inserted into the doorframe 20 during the assembly process. Once inserted into the doorframe 20, the door panel 30 is maintained in place by an adhesive 32 applied to an edge of the door panel 30 and by silicon S's on the lower surface of the U-shaped guides 26.

However, the prior art doorframe and sliding door assembly, which are constructed in the above manner, have the following, shortcomings.

First, since the doorframe is formed by bending the steel plate, the doorframe is not sufficiently stiff enough. As a result, the doorframe may easily deform or buckle.

Although the doorframe may be made from a stainless steel plate in order to increase its stiffness, the stainless steel is expensive and has a low workability, as well as being unreceptive to paint applications.

Further, the appearance Of the sliding door assembly or the doorframe is an important factor when installed at the entrance of a building. However, the bending process used to manufacture the doorframe is not conducive to producing doorframes with various appearances. Moreover, the silicon used for keeping the door panel in place makes it difficult to enhance the appearance of the doorframe.

Additionally, the above-mentioned blending process makes it difficult to produce the doorframes in an automated manufacturing line.

Finally, in order to attach the prior art doorframe to a door hanger, additional machining to the doorframe (e.g., drilling and/or tapping) must be performed in order to form a threaded hole into which a fastening member can be screwed in.

### DISCLOSURE OF INVENTION

### Technical Problem

One objective of the present invention is to provide a doorframe with increased stiffness.

Another objective of the present invention is to provide a doorframe, which does not require additional machinery for attachment to a door hanger.

Yet another objective of the present invention is to provide a doorframe that can be produced in an automated manufacturing line.

Still yet another objective of the present invention is to provide a sliding door assembly having the aforementioned doorframe.

### Technical Solution

The above objectives of the present invention can be achieved by providing a doorframe which comprises the following: a frame having an elongated first pressing leg with a first pressing surface; a second pressing leg with a second pressing surface adapted to face the first pressing surface; and a connecting portion connecting the first pressing leg and the second pressing leg adjacent their upper ends. A portion of a door panel is received between and supported by the first pressing leg and the second pressing leg. The frame is made through extrusion, and a friction member is disposed between the door panel and at least one of the pressing surfaces.

### BRIEF DESCRIPTION OF THE DRAWINGS

FIGS. 1 and 2 are perspective views of a prior art door assembly and a prior art doorframe, respectively;

FIGS. 3 and 4 are perspective views of a sliding door assembly and a doorframe, which are constructed in accordance with the present invention, respectively;

FIG. 5 is a frontal view of the doorframe shown in FIG. 4; and

FIG. 6 is an enlarged view of a recess in which a friction member is accommodated.

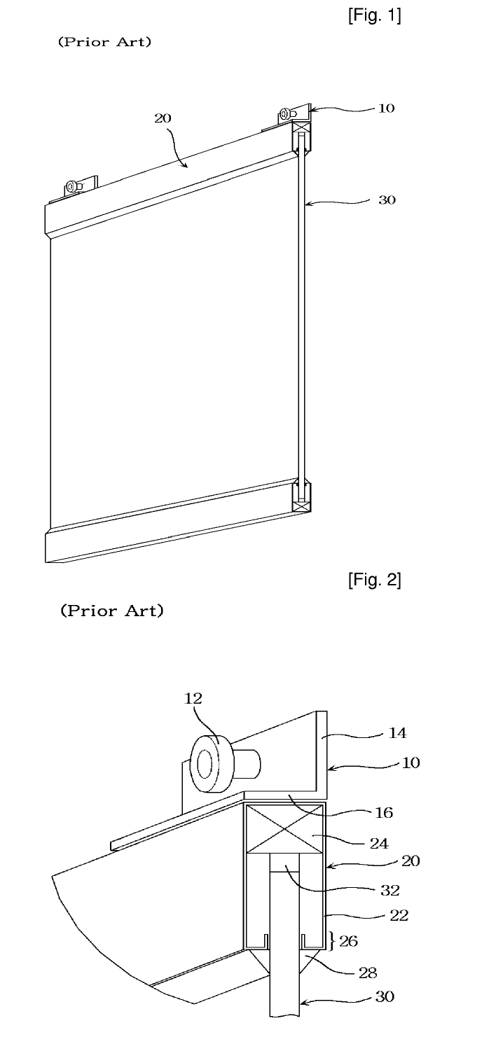

### BEST MODE FOR CARRYING OUT THE INVENTION

A preferred embodiment of the present invention will be described below with reference to the accompanying drawings.

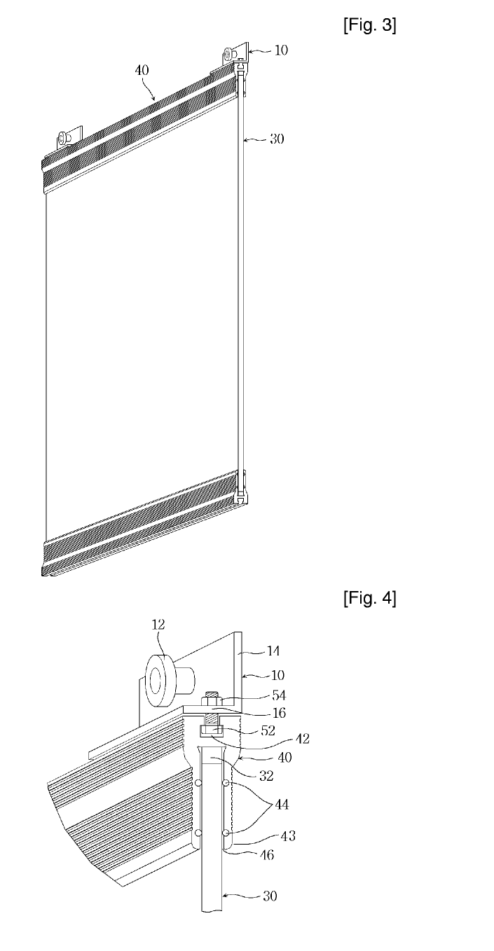

FIG. 3 illustrates a sliding door assembly constructed in accordance with the present invention. The sliding door assembly includes a door panel 30, a door hanger 10 and a doorframe 40.

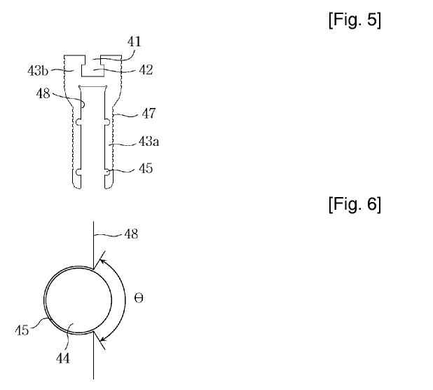

Referring now to FIGS. 4 and 5, the door panel 30, which is the portion of the present invention actually blocking an entrance, is made of a plate-like member having a predetermined thickness (e.g., strengthened glass). Adhesive 32 is applied onto the edges of the door panel 30.

The door hanger 10 connects the sliding door assembly to the automatic door opening/closing system by being attached to the rail of the automatic door opening/closing system (not shown), while further being attached to the doorframe 40. The door hanger 10 is equipped with a roller 12, which is shaped in such a manner so as to be engageable with the rail of the automatic door opening/closing system. In the preferred embodiment of the present invention, the door hanger 10 has a horizontal plate 16, which contacts the doorframe 40, and a vertical plate 14 extending from the horizontal plate 16 at a right angle. The horizontal plate 16 has many holes (not shown) through which a fastening member 52 passes.

The doorframe 40 is of a solid body and is preferably manufactured by extrusion molding. Thus, the design of the doorframe 40 results in a stiffer doorframe 40 than the prior art doorframe comprised of a hollow body and formed by bending a plate material. Accordingly, the doorframe 40 rarely buckles or deforms. Since the material of the doorframe is not limited to the material having a high stiffness, the doorframe of the present invention may be manufactured from a variety of materials. In the preferred embodiment of the present invention, the doorframe 40 is made of aluminum.

In addition to its stiffness, an advantage of using aluminum is that it can be painted easily with various colors. As a result, a greater variety of doorframe products may be developed compared to the doorframe made of stainless steel. This feature is very important when considering from an aesthetic standpoint.

Further, since extrusion molding allows for various cross-sectional shapes of the doorframes to be created, the doorframe 40 has the advantage of various shapes being visible on its surface. One example is the patent shown in FIG. 5, where alternately arranged prominences and depressions 47 are seen. This feature is another important aspect, which is not present in the prior art doorframe formed by the aforementioned bending process.

Referring now to FIGS. 4 and 5, the lower portion of the doorframe 40 has a pair of pressing legs 43a. The space between the pressing legs 43a defines the door panel-receiving groove 46, where the door panel 30 is inserted into and thereby supported. The surfaces of the pressing legs 43a, which face each other, function as a pressing surface 48 that presses against the door panel 30. Within each of the pressing surfaces 48 lies a pair of recesses 45 in which friction members 44 are accommodated. It is preferable that the distance between the pressing legs 43a be increased at the ends of the pressing leas 43a so that the door panel 30 can be easily inserted into the receiving groove 46.

The friction member 44 protrudes from the pressing surface 48 by a predetermined height and serves to keep the door panel 30 in place once the door panel 30 is seated in the door panel-receiving groove 46. During the assembly process, when the distance between the pressing legs 43a does not accommodate the thickness of the door panel 30 (due to, e.g., tolerance in manufacturing the components), assembling the door panel 30 into the doorframe 40 may be facilitated by adjusting the height of the friction members 44 above the pressing surfaces 48. For example, if the door panel 30 is not as thick as ordinary door panels 30, then increasing the height of the friction member 44 above the pressing surface 48 allows the door panel 30 to be firmly maintained between the pressing legs 43a.

Referring to FIG. 5, the doorframe 40 has a pair of protruding legs 43b extending from the upper portion of the doorframe 40 which are separated from each other to define a fastening member-receiving groove. The fastening member-receiving groove includes an upper portion 41 and a lower portion 42, wherein the lower portion 42 has a wider width than the upper portion 41.

As shown in FIG. 4, the body of the fastening member 52 is positioned in the upper portion 41, while the head of the fastening member 52 is located in the lower portion 42. The end surfaces of protruding legs 43b provide a mounting surface for the door hanger 10 to be seated on. The attachment of the doorframe 40 to the door hanger 10 is easily and promptly completed, as a result of the fastening member-receiving groove, for the following reasons. After the fastening member 52 is positioned in the upper and the lower portions 41 and 42, the door hanger 10 is positioned on the end surfaces of the protruding legs 43b. Then, the fastening, member 52 and a hole in the door hanger 10 are aligned with each other, as a mate member 54 for the fastening member 52 is tightened up to the fastening member 52. The fastening member-receiving groove makes it unnecessary to perform any drilling and/or tapping to form a threaded hole through the doorframe 40 where the fastening, member 52 is inserted, unlike in the prior art.

The pair of protruding legs 43b at the upper portion of the doorframe 40 is connected to the pair of pressing legs 43a formed at the lower portion of the doorframe 40 through portions of the doorframe 40 between the legs 43a and the legs 43b.

It is preferable that the fastening member 52 is a bolt and the mate member 54 is a nut. Various bolts having different shapes may be used as the fastening member and the widths of the upper portion 41 and the lower portion 42 can be determined according to the sizes of the head and the body of the bolts selected to be used.

Referring to FIG. 6, the friction member 44 accommodated in the recess 45 is configured to protrude from the pressing surface 4S by a predetermined height, as described above. In the preferred embodiment, the recess 45 has a circular cross-sectional shape with an opened portion where the friction member 44 is introduced. Preferably, the opened angle θ of the recess 45 is approximately 120 degrees.

It is preferable that the friction member 44 is made of a material having a large resilience and a high friction coefficient. In the preferred embodiment of the present invention, rubber is used as the friction member 44.

### INDUSTRIAL APPLICABILITY

As mentioned previously, the doorframe constructed in accordance with the present invention is of a solid body and has a high stiffness. Accordingly, the present invention doorframe allows a wider range of materials to be used for its manufacture. In particular, when materials that can be painted are used to form the doorframe (e.g., aluminum), doorframes can have various colors, thereby resulting in an enhanced esthetic factor to the present invention doorframe when compared to the prior art doorframes.

Since the doorframe in accordance with the present invention can be manufactured in an automated manufacturing line by extrusion molding, mass production of the doorframe can be achieved.

Further, because the inventive doorframe has a fastening member-receiving groove for accommodating the fastening member, the attachment of the doorframe to the door hanger can be easily and promptly completed.

In addition, the doorframe and the sliding door assembly, which are in accordance with the present invention, can be applied to sliding doors or elevator cars.

1. A doorframe, comprising:
a frame having a first pressing leg with a first pressing surface, a second pressing leg with a second pressing surface facing the first pressing surface and a connecting portion connecting the first pressing leg and the second pressing leg adjacent their upper ends, wherein a portion of a door panel is received between and supported by the first pressing leg and the second pressing leg, and wherein the frame is made through extrusion; and
a friction member disposed between the door panel and at least one of the pressing surfaces.

2. The doorframe of claim 1, wherein said connecting portion includes at its upper portion a receiving groove formed along a lengthwise direction and having an upper portion with a first width and a lower portion with a second width larger than the first width.

3. The doorframe of claim 1, wherein the pressing surface has a recess in which the friction member is accommodated.

4. A sliding door assembly, comprising:
a door panel;
a frame having a first pressing leg with a first pressing surface, a second pressing leg with a second pressing surface facing the first pressing surface and a connecting portion connecting the first pressing leg and the second pressing leg adjacent their upper ends, wherein a portion of a door panel is received between and supported by the first pressing leg and the second pressing leg, and wherein the frame is made through extrusion; and
a friction member disposed between the door panel and at least one of the pressing surfaces.

5. The sliding door assembly of claim 4, further comprising a receiving groove having an upper portion with a first width and a lower portion with a second width larger than the first width, the receiving groove being formed on an upper portion of the connecting portion; and
a door hanger having at least one hole;
wherein the door hanger is attracted to the frame by a bolt and a nut tightened up to the bolt, the head of the bolt being kept in the lower portion and the body of the bolt being kept in the upper portion with the bolt passing through the hole.

6. A doorframe for a sliding door of an elevator car, comprising:
a frame having a first pressing leg with a first pressing surface, a second pressing leg with a second pressing surface facing the first pressing surface and a connecting portion connecting the first pressing leg and the second pressing leg adjacent their upper ends, wherein a portion of a door panel for the sliding door is received between and supported by the first pressing leg and the second pressing leg, and wherein the frame is made through extrusion; and
a friction member disposed between the door panel and at least one of the pressing surfaces.
